(19) United States
(12) Patent Application Publication
(10) Pub. No.: US 2026/0194946 A1
(43) Pub. Date: Jul. 9, 2026

(54) RACK POWER ARCHITECTURE

(71) Applicant: Nvidia Corporation, Santa Clara, CA (US)

(72) Inventors: Elad Mentovich, Tel Aviv (IL); Ryan Albright, Beaverton, OR (US); David Mohr, Houston, TX (US)

(21) Appl. No.: 19/012,659

(22) Filed: Jan. 7, 2025

(51) Int. Cl. G06F 1/26

(52) U.S. Cl. CPC G06F 1/26

(57) ABSTRACT

Systems and methods disclosed herein can be used to supply power in a computing environment that may include a rack, multiple sleds, and a power-sharing logic. The rack may include a busbar, an alternating current (AC) input, and a plurality of rack power supply units (PSUs). The multiple sleds may include individual sled PSUs and power distribution board (PDBs). The power-sharing logic may be associated with the sled PSUs and the PDBs to allow sharing of power between the sled PSUs and through the PDBs.

### TECHNICAL FIELD

This disclosure relates to the sharing of power among resources, and in at least one embodiment pertains to the sharing of power within racks in a datacenter.

### BACKGROUND

Power sources in a datacenter may be increasingly distanced from a consuming entity, such as processors, of the datacenter. For instance, an external power source may be coupled to a busbar of a rack to distribute or supply power via the busbar to server trays of the rack. There may be losses in this configuration, and some server trays may be farther away from the power. Some server trays may encounter power transients from the supplied power.

### BRIEF DESCRIPTION OF DRAWINGS

FIG. 1 illustrates a datacenter that is subject to embodiments of a power-sharing logic (PSL) with sled Power Supply Units (PSUs) and Power Distribution Boards (PDBs) for power-sharing within racks in a datacenter;

FIG. 2A illustrates rack options for power-sharing configurations in a datacenter, according to at least one embodiment;

FIG. 2B illustrates sled options for power-sharing configurations in a datacenter, according to at least one embodiment;

FIG. 3A illustrates power-sharing aspects in a system for power supply in a computing environment, according to at least one embodiment;

FIG. 3B illustrates further power-sharing aspects using two sleds in a system for power supply in a computing environment, according to at least one embodiment;

FIG. 4 illustrates computer and processor aspects for a power-sharing logic used with power-sharing configurations in a datacenter, according to at least one embodiment;

FIG. 5 illustrates a process flow in power-sharing configurations in a datacenter, according to at least one embodiment;

FIG. 6 illustrates yet another process flow in a system for power-sharing configurations in a datacenter, according to at least one embodiment;

FIG. 7 illustrates a further process flow in a system for power-sharing configurations in a datacenter, according to at least one embodiment; and

FIG. 8 illustrates an example datacenter to apply at least one embodiment in FIGS. 1-7.

### DETAILED DESCRIPTION

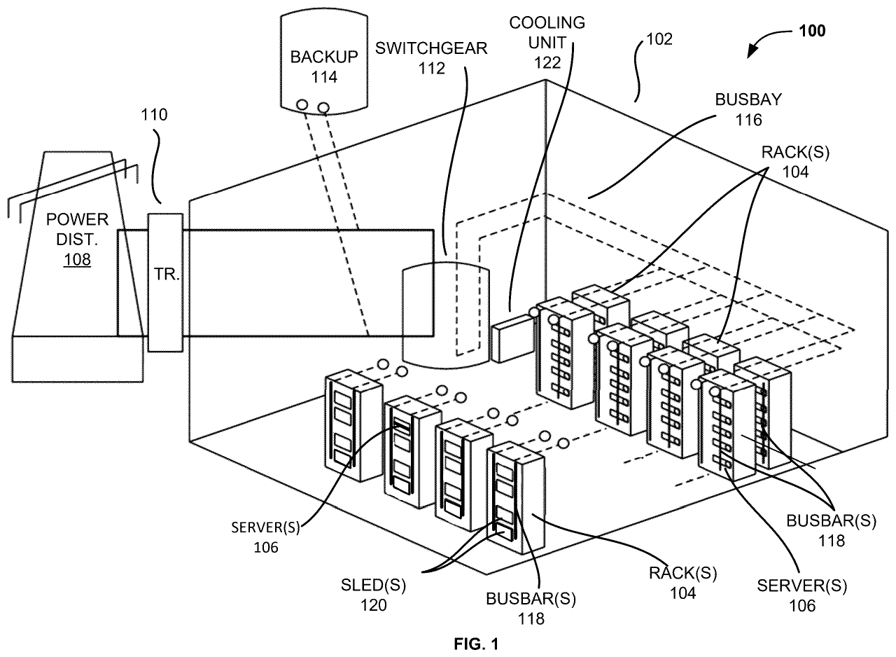

FIG. 1 illustrates a datacenter 100 that is subject to embodiments of a power-sharing logic (PSL) used with sled Power Supply Units (PSUs) and Power Distribution Boards (PDBs) for power-sharing within racks in a datacenter. The datacenter 100 may include multiple sleds installed in individual racks and having therein individual PSUs that are capable of being in a power-sharing configuration with each other. The power-sharing configuration may be so that each sled may receive power, consume power, and share power with other sleds in a rack. The sleds may include circuit boards having processors (such as central processing units (CPUs), graphics processing units (GPUs), data processing units (DPUs), or the like), and other compute devices (such as memory, communication modules, input/output modules, and the like). The sleds are capable of bringing power into the rack and are capable of power-sharing within a rack. The sleds may be capable of performing workloads using the circuit board therein and may be provided within a rack for on-the-fly computing or to support changing workload demands in a datacenter. The power-sharing configuration within a sled brings a power source closer to the processors (and the other compute devices), which consume the power. This configuration reduces losses and transients that may otherwise exist in the power supply.

In one example, each sled may be provided with a sled PSU that is horizontally positioned within a sled to power the processors. The sled PSUs may receive power from a respective rack PSU and may be associated with a busbar of the rack for power-sharing and redundancy with other sled PSUs. Further, each PSU may be associated with at least one of the PDBs to provide power and receive the power. The power-sharing configuration may be allowed, in part, by the PSL associated with each sled PSU. The PSL may allow unused power to be shared to other sleds that may be performing a more demanding workload by their respective processors, in one example. In addition, each sled PSU may be associated with a digital loop that may be programmed to change the power-sharing configuration, such as to not share to a specific neighbor sled, for instance.

The digital loop may represent an overriding of the power-sharing configuration, in one example. The PSL used with the sled PSUs and the PDBs herein brings the power supply closer to the processors of each individual sled and allows power to be shared to more demanding sleds in a rack. The digital loop may be provided via the PSL by instructions in software therein that may include a control flow statement for repeated execution of a group of instructions till a predetermined condition is satisfied. The predetermined condition may be to allow power-sharing to a specific neighboring sled, and the override by the digital loop may be an instruction to not share power to the neighboring sled. The digital loop may be periodic. For instance, based at least in part on the predetermined condition, such as a periodic time-based condition, the instruction from the digital loop may be allowed to perform or cause the override of the predetermined condition.

As used herein, a rack may be an enclosure (or chassis) that has one or more sleds. As used herein, a sled may be a separate enclosure than a rack and that may be dimensioned to fit within the rack. A sled may include power supply, power control, as well as compute devices to perform a workload. In one example, each sled may include more than one independent compute device acting as a compute node. For instance, each sled may have such compute devices that may be linked together but that may have individual operating systems (OSes). There may be multiple OSes deployed via compute devices and provided per sled.

Unless specified otherwise, a PSU may be a sled PSU. A sled with a PSL, PSUs, and PDBs may provide high-quality power for high-count GPU racks and may allow power supplies to be close or closer to GPUs and other consuming entities in a datacenter. Although illustrated in the plural, a sled may include at least one PSL, a PSU, and a PDB. The sleds with a PSL, PSUs, and PDBs allow power-sharing via a vertical power distribution, using power received from busbars and rack PSUs. With reduced losses and transients from the power supplies being positioned closer to GPUs, better performance from the GPUs may be realized.

In one example, the sleds with a PSL, PSUs, and PDBs allow power supply to be positioned vertically in a rack 104. The power supply from the sleds may directly feed compute devices that may be located horizontally within a same sled that receives the power supply or that may be located in neighboring sleds from the sled receiving the power supply and that may benefit from power-sharing of the power supply. A sled may, therefore, be self-sufficient relative to a server tray, in at least terms of power conditioning using the PSL, PSUs, and PDBs.

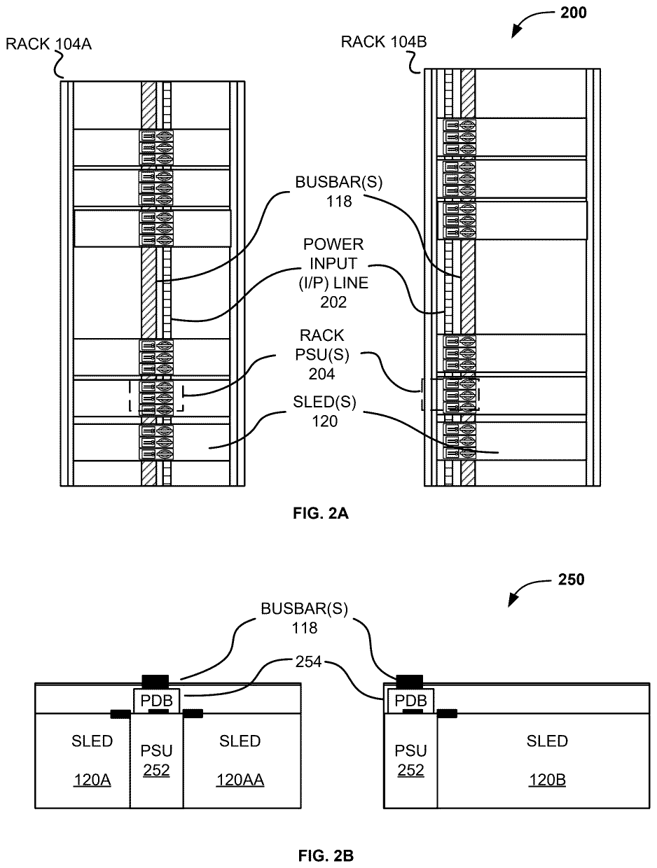

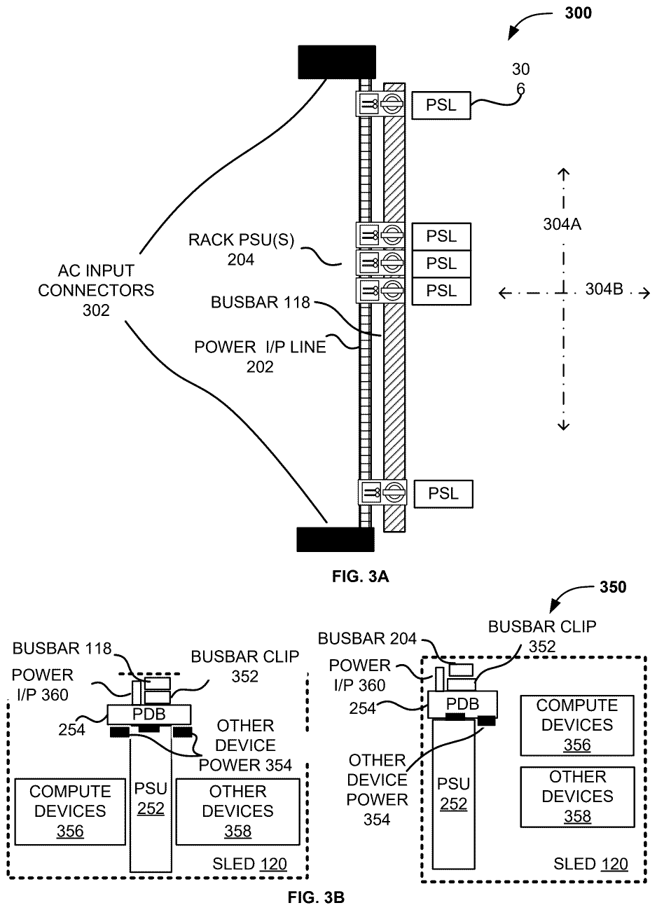

A busbar 118 of a rack 104 may be able to connect to a busbay 116 carrying a voltage suitable for the rack 104 and may be able to vertically share the power of the busbay 116. A suitable voltage may be 50 Volts (V), in one non-limiting example, and other voltages may be possibly used depending on the datacenter benefiting from the power-sharing described herein. The busbay 116 may be horizontally provided, relative to the racks 104. The busbar 118 may support a power-sharing configuration in which it may be able to provide power redundancy for sleds 120 within the rack 104. In one example, a vertical stack of power supplies represented, in part, by a vertical arrangement of multiple sleds 120 can be placed in a rack 104 so that the busbars 118, PSLs, PSUs, and PDBs are all aligned in a center, a left side, or a right side of a rack. This is illustrated and described further in connection with FIGS. 2A-3B. In a further example, a sled 120 may not need its own power supply (at least PDB part) if dependent on another sled 120 but may include aspects of the PSL to be able to receive power in the power-sharing configuration or arrangement. A sled 120 without its own power supply can fill a full width of a rack and need not have sled PSUs, for instance.

In one example, a sled may also include an alternating current (AC) to direct current (DC) converter. This may be part of a sled PSU. There may be multiple sleds 120 per rack 104, with each being of distinct power control. The datacenter 100 herein may be subject to a layout of a racks 104 in a manner that allows for row distribution of power through the busbay 116 and the busbars 118. The sleds having individual PSUs therein may be capable of being in a power-sharing configuration with each other may be so that a power shelf, which may otherwise be attached to the bottom of a ranger-type sled and provided with a busbar from the power shelf, can provide power to compute devices within the sled but can also share power to other sleds 120 in the rack 104. There may be eight or more sleds 120 in such racks 104 and each sled 120 may be dimensioned to be less than a width of a bare metal rack 104X so that each sled 120 may be slipped into the rack 104.

In at least one embodiment, the datacenter 100 may include one or more rooms 102 of racks 104, where the racks 104 may include server trays or computer modules 106. The datacenter 100 may be powered from a power distribution 108 system, via one or more transformers 110 (Tr.), so that power to a switchgear 112 may be suitable for the datacenter. For instance, the power distribution 108 system may be part of a transmission system. The transmission system may provide high-voltage electricity from a utility grid. Each transformer 110 may step down the voltage to a level suitable for the datacenter's equipment and devices, such as the aforementioned processors that may be within the server trays or computer modules 106 in each rack 104.

The switchgear 112 may be able to control, protect, and isolate power in both downstream and upstream directions. The switchgears 112 may be used to manage the flow of electricity in a reliable and efficient manner using switching of electrical circuits for controls and using breakers and fuses to detect and respond to faults or overloads in both downstream and upstream directions. In addition to an external source represented by the transmission systems and to ensure uninterrupted power supply, a backup 114 system, such as a generator or Uninterruptible Power Supply (UPS), may be used with the power distribution 108 system (Power Dist.).

The switchgear 112 may be associated with busbay 116. The busbay 116 may provide power to one or more racks 104. In one example, the busbay 116 may provide power to one or more racks 104 through provided busbars 118. The busbars 118 may be conductive bars that carry electrical current to various loads, including those represented by the aforementioned processors, which may be within the server trays or computer modules 106 in each rack 104 of the datacenter 100. The server trays or computer modules 106, different than the sleds 120, may not be self-sufficient with respect to power-sharing configurations.

The busbars 118 may be provided from copper, aluminum, or a suitable power delivery material. The busbars 118 may be able to handle high-current demands of the datacenter 100. In one example, the busbars 118 may be connected to PDBs, such as discussed in FIGS. 2A-3B, herein, and the PDBs may distribute power to individual compute devices of a sled 120 (such as in FIGS. 2A-3B) and to other sleds 120 of the rack 104, in a power-sharing configuration. In addition, although illustrated as provided from above, the racks 104 and the busbay 116 may be provided below the racks 104 and may allow a power connection between the busbay 116 and a power input of each of the racks 104.

FIG. 2A illustrates rack options 200 for power-sharing configurations in a datacenter, according to at least one embodiment. In one instance, a system of racks 104A, 104B may be provided with a power supply in a computing environment, such as a datacenter 100, using at least one sled 120 having its own sled PSU and PDB (252, 254, detailed in FIG. 2B) to receive power from a power input (I/P) line 202, through one or more rack PSU(s) 204. Although illustrated as a single busbar 118, a rack 104A, 104B may have multiple busbars 118. A sled 120 intended to be used in a power-sharing configuration may include its own sled PSU and the PDB, which may allow it to share power that is unused within the sled to other sleds.

The power I/P line 202 feature in a rack 104A, 104B may be shared within the rack and may run parallel with the busbar 118. The power I/P line 202 may receive an alternating current (AC) or direct current (DC) input and may provide the power as to the rack PSUs 204. The rack PSUs 204 may provide power to individual sled PSUs 252 of the provided sled PSU and PDB 252, 254 in FIG. 2B. The busbar 118, power I/P line 202, and the rack PSU 204 may be located towards a rear of the rack 104A, 104B. The sled PSU 252, PDB 254 are located from the front to a rear of individual sleds 120. Therefore, the view in FIG. 2A may be of a rack 104A, 104B from a front view, and may be of a visible busbar 118, power I/P line 202, rack PSU 204, sled PSU 252, and PDB 254 at the rear of each rack, but without compute devices of a circuit board or other requirements, including cooling requirements provided by a cooling unit 122, that may be used with one or more of the racks 104A, 104B or the compute devices therein. In one example, the cooling unit 122 may provide at least air cooling in the datacenter 100.

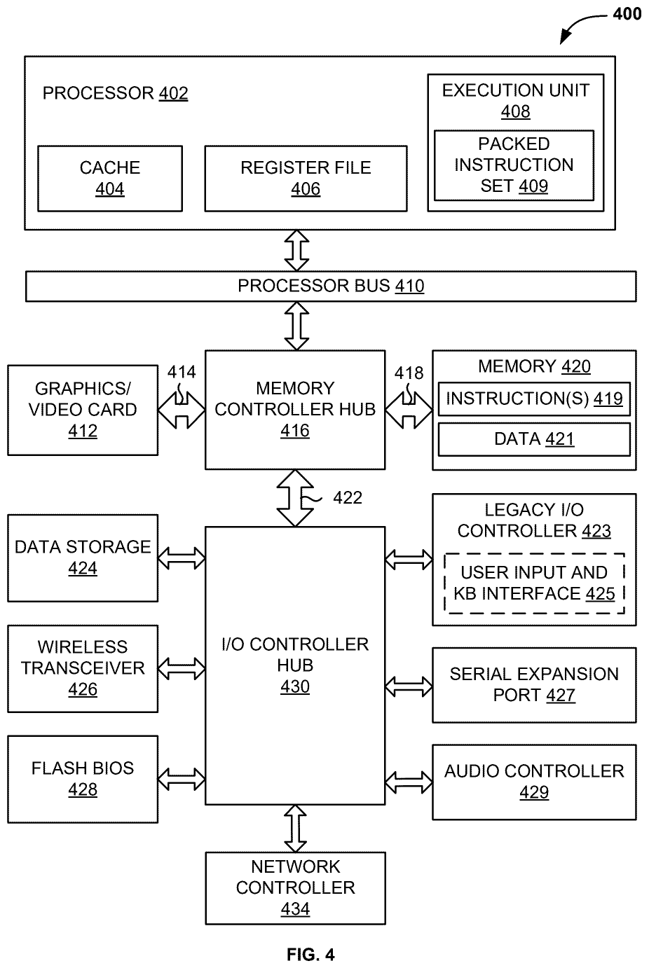

The view in FIG. 2A may also illustrate locations of the busbar 118, rack PSU 204, sled PSU 252, PDB 254, and power I/P line 202 as being at a center (left side rack 104A in FIG. 2A) or a side (right side rack 104B in FIG. 2A), representing rack options, in each rack 104A, 104B. Further, a rack 104A, 104B may include multiple sleds 120 with or without sled PSUs 252. The sleds 120 may have at least the PDB to be able to receive and share power as part of the power-sharing configuration or arrangement. A PSL (306, in FIG. 3A, and detailed with respect to FIGS. 3A and 4) may be associated with the sled PSUs 252 and PDBs 254 to allow sharing of power between the sled PSUs 252 and through at least the PDBs 254.

FIG. 2B illustrates sled options 250 for power-sharing configurations in a datacenter, according to at least one embodiment. In one instance, the sled options 250 may be tied to the rack options 200 in FIG. 2A. For instance, each rack 104A, 104B may include at least one sled 120 having its own PSU 252 and PDB 254. The view in FIG. 2B may be a plan view of a rack 104A, 104B or a sled 120. The busbar 118, PSU 252, and PDB 254 may be located at a center (left side sled 120A, 120AA) or at a side (right side sled 120B). In one example, there may be multiple sleds 120 at each tier or level of a rack 104A, 104B, with one sled having its own sled PSU 252, PDB 254, and to support a side-by-side sled without its own sled PSU 252 but having a PDB 254. The power I/P line 202 may be coupled to one sled PSU 252 through provided rack PSUs 204 but the other sled without its own PSU 252 may receive power from the sled having the sled PSU 252, through the busbar 118.

The view in FIG. 2B may be of a sled 120A, 120AA, 120B with a visible plan view of a busbar 118, sled PSU 252, and PDB 254, but without compute devices of a circuit board or other requirements, including cooling, which may be used with the compute devices. The view in FIG. 2B may also illustrate locations of at least the busbar 118, sled PSU 252, and PDB 254, as at a center, a right side, or left side, representing sled options 250, of the sleds 120 in a rack 104. All sleds may need to have the same option of such sled options 250 to allow alignment with at least the power I/P line 202 and the busbar 118 of the rack 104. Further, a PSL (306 in FIG. 3A) may be associated with the sled PSUs 252 and PDBs 254 and may allow sharing of power between the sled PSUs 252 and through at least the PDBs 254, at a same tier or level or across multiple tiers or levels of a rack 104.

FIG. 3A illustrates power-sharing aspects 300 in a system for power supply in a computing environment, according to at least one embodiment. The power-sharing aspects 300 illustrate that one or more AC input connectors 302 may be used to couple the power I/P 202 to a busbay 116 of a datacenter 100. Power from the AC input connectors 302 may pass through the rack PSUs 204 to the sled PSUs 252 and the PDBs 254. The power may be AC power provided through one or more of the AC input connectors 302. The power may be shared from one of the sleds 120A to one or more of the other sleds 120AA, 120B via the busbar 118. Each sled PSU 252 may be associated with a rack PSU 204, as illustrated, and may receive DC power after conversion in the rack PSU 204. In one example, it is possible for the sled PSU 252 to receive AC power from the AC input connectors 302 and through the rack PSU 204. The sled PSU 252 or the rack PSU 204 may be able to convert the AC power from the power I/P line 202 to DC power for powering the compute devices and other components of each sled 120.

In one example, one rack PSU 204 may support multiple sleds 120a, 120aa, 120b. In another example, each sled 120 may be associated with a corresponding rack PSU 204. A rack PSU 204 or sled PSU 252 may provide the conversion of AC power to DC power. Therefore, it is possible for each rack PSU 204 or sled PSU 252 to receive AC power, but it is also possible for the sled PSU 252 to receive only DC power. Each sled PSU 252 may be scalable within the sled 120 to provide more or less power for computing and other devices. Each rack PSU 204 may be similarly scalable at the rack level, for multiple sleds 120. The less power consumed in one sled 120A may support power-sharing from the one sled 120A to another sled 120AA, 120B using the PSL 306 in combination with a PDB 254 of the provided sled PSU 252. Each sled PSU 252 or rack PSU 204 may also regulate power to ensure that at least the compute devices receive an intended voltage and current.

Each PDB 254 may be able to distribute power to compute devices of a sled 120 from the power I/P line 202 but may also provide power to another sled PSU 252 through the busbar 118, in a power-sharing configuration. A respective sled PSU 252 may, in turn, provide the intended voltage and current to compute or other devices within a sled 120A, AA, B. Each PDB 254 may be scalable to operate across multiple sleds 120, representing a rack-level distribution of power, in the power-sharing configuration, to multiple sleds 120 of a rack 104. To do so, each PBD 254 of each sled 120 may be able to use the busbar 118 of its rack 104 to supply excess power to a neighboring sled 120. Each PDB 254 may also perform power monitoring, switching, and surge protection for its respective sled 120. At least the power monitoring aspects may be associated with respective PSLs 306 to allow or to support the power-sharing configuration between multiple sleds 120.

Each PSL 306 of the power-sharing aspects 300 may include first instructions for a default power-sharing configuration. Each PSL 306 of the power-sharing aspects 300 may include second instructions to override the default power-sharing configuration based at least in part on input selecting one or more of the sled PSUs 252 to receive power from a PDB 254 or to be bypassed. A PSL 306 may include a processor and memory having the first and the second instructions to be executed on the processor to allow the default power-sharing configuration and the override to the default power-sharing configuration. The processor and memory aspects for a PSL 306 may be as detailed in connection with at least FIG. 4. The PSL 306 may be configured to allow the sharing of the power from the power I/P line 202 to also provide or support redundancy in power for at least a first one of the sled PSUs 252 (in a first sled 120A, for instance) from a second one of the sled PSUs 252 (in a second sled 120B, for instance) in a rack 104. The redundancy may be also supported or allowed in part by the processor and memory aspects of a PSL 306. The redundancy is with respect to an ability of one sled PSU sharing power via its PDB to another sleds PSU.

FIG. 3B illustrates further power-sharing aspects 350 using two sleds in a system for power supply in a computing environment, according to at least one embodiment. In the left side sled 120, the power-sharing aspects 350 are provided and aligned in the center of the sled. On the right side sled 120, the power-sharing aspects 350 are provided aligned to one side of the sled. The power-sharing aspects 350 may apply to each PDB 254 of the rack 104. The rack PSUs 204 may be positioned vertically 304A in the rack 104, as illustrated in at least FIG. 2A. Then, individual ones of the rack PSUs 204 may supply power received from the power I/P line 202, via power I/P 360, to the individual sled PSUs 252 that are positioned horizontally 304B within individual ones of the sleds 120. The power I/P 360 may be a clip that may clip to the power I/P line 202 in a similar manner as the busbar clip 352 does with the busbar 118. The busbar 118 may also be positioned vertically 304A to connect with the PDBs 252 and to perform at least part of the sharing of the power between the sled PSUs 252.

The rack PSUs 204 may be also positioned vertically 304A in a center or side of the rack 104 to allow access between the rack PSUs 204 and the sled PSUs 252, based at least in part on a configuration of one or more circuit boards associated with the sled PSUs 252. Further, the rack PSUs 204 are able to provide direct current (DC) power to the sled PSUs based at least in part on conversion of AC power from the AC input received to the rack PSUs 204 (at the AC input connectors 302, for instance). The sled PSUs 252 may be able to provide the DC power to compute devices, based at least in part on conversion of the AC power as received from the AC input of the rack 104. The rack PSU 204 may be able to provide the AC power to the sled PSUs 252. The sled PSUs 252 may perform conversion of the AC power from the AC input received therein. The sled PSUs 252 may be able to provide the DC power based at least in part on conversion of the AC power as received from the AC input of the rack 104.

The PDBs 254 may include at least a busbar clip 352. The busbar clip 352 may allow for push-and-pull association and disassociation, with the busbar 118, for each of the sleds 120. Such a push-and-pull association of the sleds to the rack may support a plug-and-play installation of the sleds with respect to the rack to suit workload demands at any time in a datacenter 100. The PDBs 254 may include outputs for other device power 354 that may be used for cooling components or other devices 358 that are not compute devices 356. The compute devices 356 may be powered from the PSU 252.

FIG. 4 illustrates computer and processor aspects 400 for a power-sharing logic 306 used with power-sharing configurations in a datacenter, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, data processing units (DPUs), and graphics processing units (GPUs) and may be within the PSL 306, but that may also benefit from the power-sharing logic used with sled PSUs and PDBs, as described all throughout herein.

The computer and processor aspects 400 may include a PSL 306 which may be associated with sled PSUs and power distribution boards (PDBs) of a rack. The PSL allows sharing of power between the sled PSUs and through the PDBs. The power sharing may be based at least in part on AC power received for the sled PSUs from one or more rack PSUs of a rack. The rack may include a busbar to support the sharing of the power. The rack may include an AC input to receive the AC power for the one or more rack PSUs or the sled PSUs. The PSL 306 may include the first instructions and the second instructions as described with respect to FIGS. 2A-3B for a default power-sharing configuration and for overriding the power-sharing configuration based at least in part on input selecting one or more of the sled PSUs to receive power or to be bypassed. One or more of such default power-sharing configuration or overriding of the power-sharing configuration may be performed by the processor 402 processing instructions from the memory 420. The computer and processor aspects 400 may also benefit from the power-sharing configuration by being within a sled 120 that may be in a power-sharing configuration with another sled not having the PSL 306 or the sled PSU 252. The PSL 306 may be configured to allow the sharing of the power to also provide redundancy in power for at least a first one of the sled PSUs from a second one of the sled PSUs.

In at least one embodiment, the computer and processor aspects 400 may include, without limitation, a component, such as a processor 402 to employ execution units including logic to perform algorithms for process data, in accordance with the present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), a system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3B and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

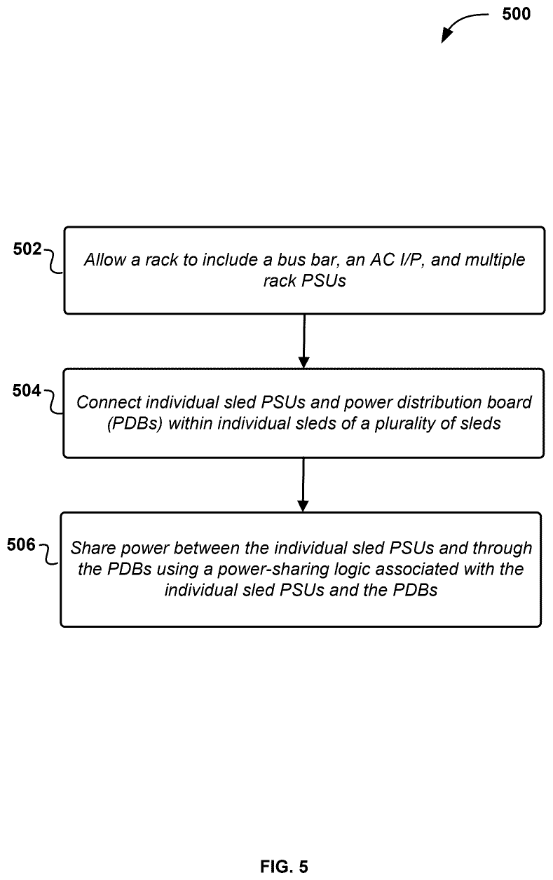

FIG. 5 illustrates a process flow or method 500 in power-sharing configurations in a datacenter, according to at least one embodiment. The method 500 may include a step to allow 502 a rack to include a busbar, a power I/P line, power I/P, and multiple rack PSUs. The method 500 may include a further step to connect 504 individual sled PSUs and PDBs within individual sleds of a plurality of sleds. The method 500 may include verifying or determining that devices, including compute and other devices, are to be powered. The method 500 may include a step to share 506 power between the individual sled PSUs and through the PDBs using a power-sharing logic associated with the individual sled PSUs and the PDBs. The method 500 may be found in a method to manufacture for system providing power-sharing configuration for use with racks and sleds. The method 500 may be found in manufacturing of sleds to support the power-sharing configuration. The method 500 may be found in use of the sleds and racks to include the power-sharing configuration.

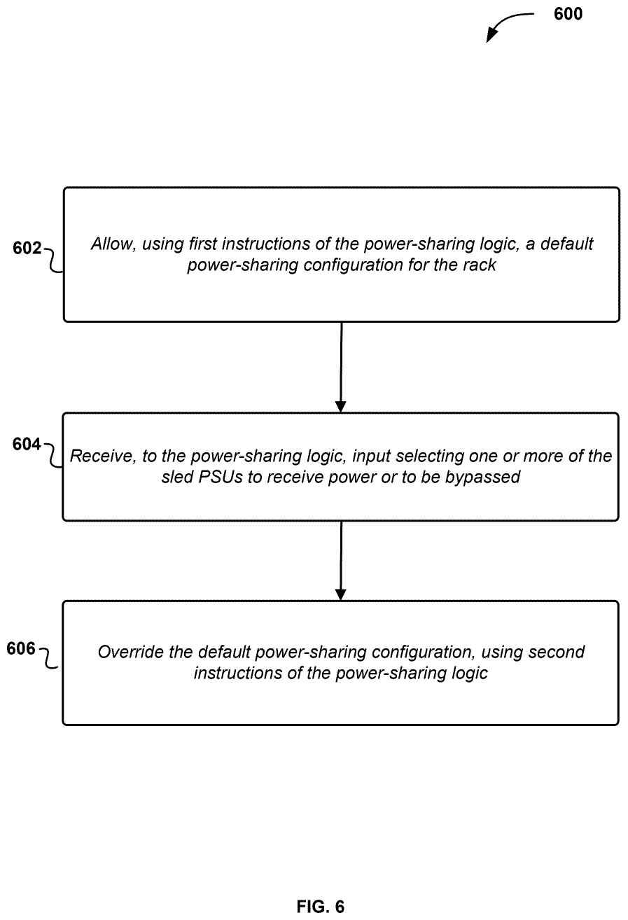

FIG. 6 illustrates yet another process flow or method in a system for power-sharing configurations in a datacenter, according to at least one embodiment. The method 600 may be in support of the method 500 in FIG. 5. For example, the method 600 may include a step to allow 602, using first instructions of the power-sharing logic, a default power-sharing configuration for the rack. The method 600 may include a step to receive 604, to the power-sharing logic, input selecting one or more of the sled PSUs to receive power or to be bypassed. In one example, the receiving 604 step may be performed in conjunction with the system of the computer and processor aspects 400 in FIG. 4 and the sharing 506 step of the method 500 in FIG. 5. For instance, the input may be received in the computer and processor aspects 400.

A step for determining or verifying may be performed for the input in step 604. The determining or verifying for the input may be to ensure (or determine) that predetermined code in the second instructions is matched or associated with an override so that the input to indicate the override is correctly provided, for instance. The method 600 may include a step to override 606 the default power-sharing configuration, using second instructions of the power-sharing logic. One or more of the steps 602-606 may be performed by the processor 402 of the computer and processor aspects 400 using instructions in the memory 420. The computer and processor aspects 400 may be part of one or more PSLs 306.

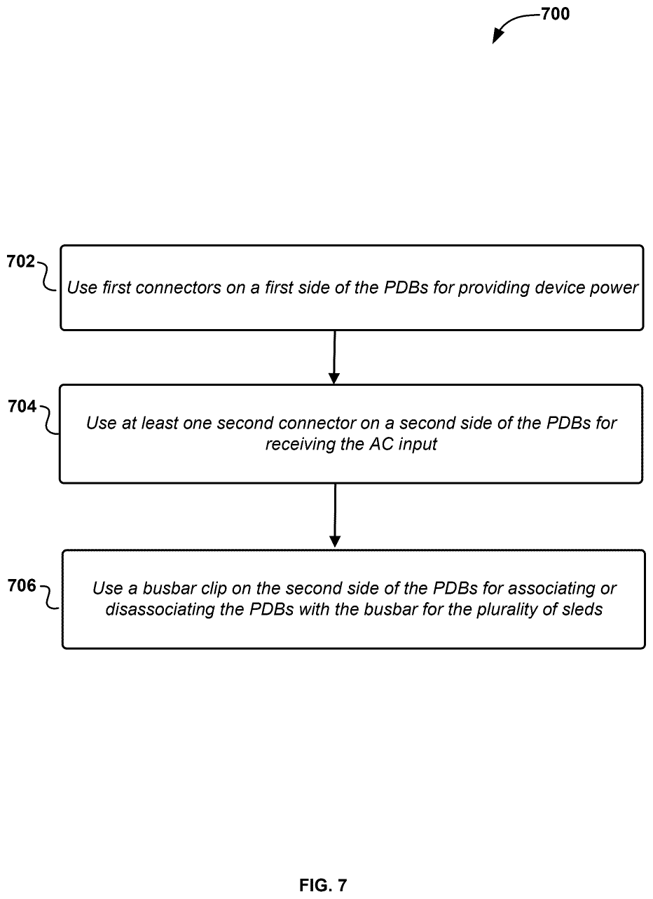

FIG. 7 illustrates a further process flow or method 700 in a system for power-sharing configurations in a datacenter, according to at least one embodiment. The method 700 may be in support of one or more of the method 500 in FIG. 5 or the method 600 in FIG. 6. For example, the method 700 may include a step to use 702 first connectors on a first side of the PDBs for providing device power. The method 700 may include a further step to use 704 at least one second connector on a second side of the PDBs for receiving the AC input. The method 700 may include yet another step to use 706 a busbar clip on the second side of the PDBs for associating or disassociating the PDBs with the busbar for the plurality of sleds. Between any step in the method 700 in FIG. 7, a determination or verification may be performed for settings required to be performed for power sharing, prior to the association of the busbar with the individual ones of the sleds.

One or more of the methods 500-700 may include positioning the one or more rack PSUs vertically in the rack. Such method or methods may include supplying power, using individual ones of the one or more rack PSUs, to the individual sled PSUs that are positioned horizontally within individual ones of the plurality of sleds. One or more of the methods 500-700 may include steps or sub-steps for positioning the busbar vertically, connecting two or more of the individual sled PSUs, and performing at least part of the sharing of the power between the sled PSUs. One or more of the methods 500-700 may include allowing, using the power-sharing logic, the sharing of the power to also provide redundancy in power for at least a first one of the sled PSUs from a second one of the sled PSUs.

One or more of the methods 500-700 may include positioning the one or more rack PSUs vertically in a center or side of the rack. Such method or methods may include allowing access between the one or more rack PSUs and the sled PSUs based at least in part on the positioning and in part on a configuration of one or more circuit boards within the sled PSUs. One or more of the methods 500-700 may include providing, using the one or more rack PSUs, DC power to the sled PSUs based at least in part on conversion of AC power from the AC input received therein. One or more of the methods 500-700 may include providing, using the sled PSUs, the DC power based at least in part on conversion of the AC power as received from the AC input of the rack.

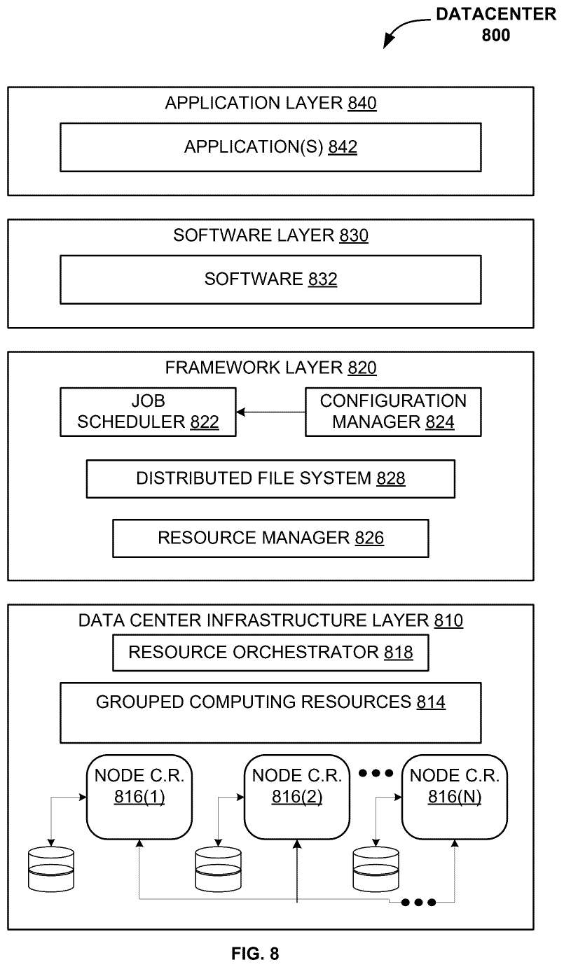

FIG. 8 illustrates an example datacenter 800 to apply at least one embodiment in FIGS. 1-7. In at least one embodiment, datacenter 800 includes a datacenter infrastructure layer 810, a framework layer 820, a software layer 830, and an application layer 840. The example datacenter 800 may use a PSL with sled PSUs and PDBs as described in FIGS. 1-7. The datacenter 800 may be as illustrated and described with respect to FIG. 1, in which, multiple sleds may be installed in individual racks and may include circuit boards having processors (such as CPUs, GPUs, DPUs, or the like (also described as node computing resources (node C.R. s 816(1)-816(N)), and other compute devices described with respect to the data infrastructure layer 810. The sleds are capable of bringing in a power-sharing configuration to a rack. The sleds may be capable of performing workloads using the circuit board therein and may be provided for on-the-fly computing or to support changing workload demands in a datacenter. The power-sharing configuration within a sled brings a power source closer to the processors (and the other compute devices), which consume the power. This configuration reduces losses and transients that may otherwise exist in the power supply.

In at least one embodiment, as shown in FIG. 8, datacenter infrastructure layer 810 may include a resource orchestrator 818, grouped computing resources 814, and node computing resources (“node C.R. s”) 816(1)-816(N), where “N” represents any whole, positive integer. In at least one embodiment, node C.R. s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R. s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in datacenters at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 818 may configure or otherwise control one or more node C.R.s 816(1)-816(N) and/or grouped computing resources 814. In at least one embodiment, resource orchestrator 818 may include a software design infrastructure (“SDI”) management entity for datacenter 800. In at least one embodiment, resource orchestrator 818 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of datacenter 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at datacenter infrastructure layer 810. In at least one embodiment, resource manager 826 may coordinate with resource orchestrator 818 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 818 may implement any number and type of self-modifying actions based on any amount and type of data acquired in any technically feasible fashion. In at least one embodiment, self-modifying actions may relieve a datacenter operator of datacenter 800 from making possibly bad configuration decisions and possibly avoiding underused and/or poor performing portions of a datacenter.

In at least one embodiment, datacenter 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 800. In at least one embodiment, trained machine learning models corresponding to one or more neural networks may be used to infer or predict information using resources described above with respect to datacenter 800 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for power supply in a computing environment, comprising:
a rack comprising a busbar and one or more rack power supply units (PSUs);
a plurality of sleds comprising sled PSUs and power distribution board (PDBs); and
power-sharing logic associated with the sled PSUs and the PDBs to allow sharing of power, received from the one or more rack PSUs, between the sled PSUs and through the PDBs.

2. The system of claim 1, wherein the power-sharing logic comprises first instructions for a default power-sharing configuration and comprises second instructions to override the default power-sharing configuration based at least in part on input selecting one or more of the sled PSUs to receive the power or to be bypassed.

3. The system of claim 1, wherein the one or more rack PSUs are positioned vertically in the rack and wherein individual ones of the one or more rack PSUs supply the power to the sled PSUs that are positioned horizontally within individual ones of the plurality of sleds.

4. The system of claim 1, wherein the busbar is positioned vertically to allow connections thereto from and to perform at least part of the sharing of the power between the sled PSUs.

5. The system of claim 1, wherein the power-sharing logic is configured to allow the sharing of the power to also provide redundancy in the power for at least a first one of the sled PSUs from a second one of the sled PSUs.

6. The system of claim 1, wherein the one or more rack PSUs are positioned vertically in a center or side of the rack to allow access between the one or more rack PSUs and the sled PSUs, based at least in part on a configuration of one or more circuit boards within the sled PSUs.

7. The system of claim 1, wherein the one or more rack PSUs are to receive alternating current (AC) power and are to provide direct current (DC) power to the sled PSUs based at least in part on conversion of AC power from the AC input received therein or wherein the sled PSUs are to provide the DC power based at least in part on conversion of the AC power as received from the AC input of the rack.

8. The system of claim 1, wherein the one or more rack PSUs are to receive and to provide AC power to the sled PSUs, wherein the sled PSUs are to perform conversion of the AC power from the AC input received therein or wherein the sled PSUs are to provide DC power based at least in part on conversion of the AC power as received from the AC input of the rack.

9. The system of claim 1, wherein the PDBs comprise at least a busbar clip for push-and-pull association and disassociation, with the busbar, for the plurality of sleds.

10. A power-sharing logic associated with sled power supply units (PSUs) and power distribution boards (PDBs) of a rack, the power-sharing logic to allow sharing of power between the sled PSUs and through the PDBs, based at least in part on AC power received for the sled PSUs from one or more rack PSUs of a rack, the rack comprising a busbar to support the sharing of the power and comprising an alternating current (AC) input to receive the AC power for the one or more rack PSUs or the sled PSUs.

11. The power-sharing logic of claim 10, wherein the power-sharing logic comprises first instructions for a default power-sharing configuration and comprises second instructions to override the default power-sharing configuration based at least in part on input selecting one or more of the sled PSUs to receive the power or to be bypassed.

12. The power-sharing logic of claim 10, wherein the power-sharing logic is configured to allow the sharing of the power to also provide redundancy in the power for at least a first one of the sled PSUs from a second one of the sled PSUs.

13. A method for power supply in a computing environment, comprising:
allowing a rack to comprise a busbar, an alternating current (AC) input, and one or more rack power supply units (PSUs);
connecting individual sled PSUs and power distribution board (PDBs) within individual sleds of a plurality of sleds; and
sharing power between the individual sled PSUs and through the PDBs using a power-sharing logic associated with the individual sled PSUs and the PDBs.

14. The method of claim 13, further comprising:
allowing, using first instructions of the power-sharing logic, a default power-sharing configuration for the rack;
receiving, to the power-sharing logic, input selecting one or more of the sled PSUs to receive the power or to be bypassed; and
overriding the default power-sharing configuration, using second instructions of the power-sharing logic.

15. The method of claim 13, further comprising:
positioning the one or more rack PSUs vertically in the rack; and
supplying the power, using individual ones of the one or more rack PSUs, to the individual sled PSUs that are positioned horizontally within individual ones of the plurality of sleds.

16. The method of claim 13, further comprising:
positioning the busbar vertically;
connecting two or more of the individual sled PSUs; and
performing at least part of the sharing of the power between the sled PSUs.

17. The method of claim 13, further comprising:
allowing, using the power-sharing logic, the sharing of the power to also provide redundancy in the power for at least a first one of the individual sled PSUs from a second one of the individual sled PSUs.

18. The method of claim 13, further comprising:
positioning the one or more rack PSUs vertically in a center or side of the rack; and
allowing access between the one or more rack PSUs and the individual sled PSUs based at least in part on the positioning and in part on a configuration of one or more circuit boards within the sled PSUs.

19. The method of claim 13, further comprising:
providing, using the one or more rack PSUs, direct current (DC) power to the sled PSUs based at least in part on conversion of AC power from the AC input received therein; or
providing, using the sled PSUs, the DC power based at least in part on conversion of the AC power as received from the AC input of the rack.

20. The method of claim 13, further comprising:
using first connectors on a first side of the PDBs for providing device power;
using at least one second connector on a second side of the PDBs for receiving the AC input; and
using a busbar clip on the second side of the PDBs for associating or disassociating the PDBs with the busbar for the plurality of sleds.
